(19) United States
(12) Patent Application Publication
(10) Pub. No.: US 2022/0338570 A1
(43) Pub. Date: Oct. 27, 2022

(54) Headpiece with Adjustable Elastic Cord and Ball

(71) Applicant: Caleb Kim, Flushing, NY (US)

(72) Inventor: Caleb Kim, Flushing, NY (US)

(21) Appl. No.: 17/726,499

(22) Filed: Apr. 21, 2022

Related U.S. Application Data
(60) Provisional application No. 63/177,508, filed on Apr. 21, 2021.

(51) Int. Cl. A41D 20/00; A63B 69/00

(52) U.S. Cl. CPC A41D 20/00; A63B 69/004; B33Y 80/00

(57) ABSTRACT

A headpiece apparatus comprising of a headband member having a frontal holster, a removable 3D printed component secured to said frontal holster of said headband, and an elastic cord with one end anchored within a ball and the other end entering through said 3D printed component, circumventing said headband before and finally exiting out the said 3D printed component. The said 3D printed component which was created with thermoplastic elastomer, holsters a barrel lock which enables the user to freely change the length of the elastic cord to their preference.

### BACKGROUND OF THE INVENTION

This invention, by Caleb Kim, is a training equipment for (but not limited to) combat sports that utilizes a great deal of hand-eye coordination, kinesthetics, and cardiovascular endurance. Although previous and former models were documented, it was popularized in the media by former lightweight boxing champion, Vasyl Lomachenko. This training equipment is essentially a ball attached at the end of an elastic cord with the other end circumventing a head piece and tied down. The primary focus and use for the equipment is to consecutively strike the ball with one's fists while maintaining a controlled rhythm.

Previous iterations introduced repetitive problems. One end of the elastic cord was always fixed on to the headpiece, which meant the length was fixed. This in turn limited the elastic output from the cord, restricting the user from their true potential training. Hypothetically, if the user wished to change the cord's length, the entire cord would have been untied, measured to the user's preference, and then tied to the end of the head piece with excess cordage. Overall, a tedious effort if the equipment's attempted length was unfavorable or shared with others. Furthermore, previous models compromised the surface area of the ball with uneven protrusions where the elastic cord anchored. This in turn broadened the problems related to accuracy, precision and general user experience.

### BRIEF SUMMARY OF THE INVENTION

This invention capitalized on the issues surrounding past models. The new and improved model is genuinely tailored as a “one size fits all” training equipment which accommodates for all head sizes. More importantly, the elastic cord's length is adjustable to the user's preference without having to compromise the structural integrity of the product through a detachable, 3D printed slide and holster. Aside from its adjustable capabilities, the setup upon which the cord attaches to the ball was revolutionized as well. Instead of having protruding attachments that compromised the surface area of the ball, the elastic cord is instead tied to the base of a metal bobby pin, bent at a forty five degree angle and inserted within the ball through a small incision no larger than a centimeter in length. In this case, the bobby pin acts as an anchoring agent within the ball and minimizes the use of the ball's surface area to a maximum equivalent of the elastic cord's diameter of 2.5 mm. User's can now take advantage of a smoother surface area, which can translate to an increase in precision and accuracy. Additionally, allowing the cord to adjust easily enables the user to personalize their use in regards to speed and elasticity. Essentially, these new features withdraw the limitations set forth by previous models and drive a more user friendly experience, tailored to their specifications.

### BRIEF DESCRIPTION OF THE SEVERAL VIEWS OF THE DRAWING

FIG. 1: Invention laid flat showing its left side. Vertically symmetric down the midline of the 3D printed component.

1A: 2 Inch Elastic Band—20 inches in length

1B: ¾ Inch Grosgrain Ribbon—2 inches in length stitched on to the elastic band

1C: 1 Inch Fold Over Elastic—6 inches in length stitched on to the elastic band acting as a tunnel on both sides of the headpiece

1D: ⅛ Inch Bean Cord Lock—anchors the excess cord to the back of the user's head as it circumvents the entire headpiece.

FIG. 2: 3D Printed Top Slide. Constructed with TPE (Thermoplastic Elastomer) via FDM printer

2A: Front View—Holster for a barrel cord lock is located within the center, with an opening to let the cord freely pass through

2B: Back View—Two parallel semi-circle hollow channels to allow a portion of the back plate to anchor through the bottom and for the elastic cord to travel freely through the top

2C: ¼ Inch Barrel Cord Lock—Allows the user to freely change the length of the elastic cord

FIG. 3: 3D Printed Back Plate. Constructed with TPE (Thermoplastic Elastomer) via FDM printer

3A: Front View—Vertically symmetric down the midline with a semi-circle bar running horizontal which fits exactly with the lower back hollow channel behind FIG. 2.

3B: Side View—90 degree overhangs that hold FIG. 2 when it slides into place, along with the semi-circle bar that fits behind FIG. 2's lower channel.

FIG. 4: Ball with an elastic cord tied to a metal bobby pin and anchored within.

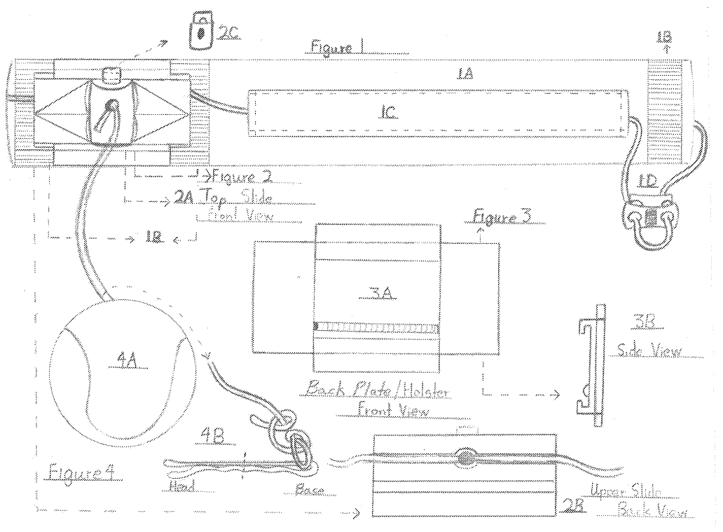

4A: Ball—an incision no larger than 10 mm is made on the surface area to insert the anchoring agent which consists of a metal bobby pin tied to the end of elastic cord

4B: Metal Bobby Pin and 2.5 mm Elastic Cord—The figure shown is a detailed depiction on how to tie the 5 foot long elastic cord to the end of the pin. The kink within the middle signifies the point to be bent at a 45 degree angle.

### DETAILED DESCRIPTION OF THE INVENTION

The two part, 3D printed components are the highlights of the invention. Custom designed on a 3D CAD software and sliced with a slicer program such as Cura, the 3D printed components consist of a top slide, and a bottom holster which holds the top slide in place. The prints were manifested with the aid of an FDM (Filament Deposition Modeling) printer, and the filament used was thermoplastic elastomer with a shore hardness of 82 A; which allowed for durability and flexibility. The top slide holds a barrel cord lock which essentially enables the user to easily adjust the length of the elastic cord without having to take it apart. The bottom holster is held down by grosgrain pockets sewn on each end to the headpiece.

The headpiece base of choice was a two inch wide elastic band. Both ends of the elastic would come together and be stitched down by a piece of grosgrain to create an elastic headband. Two tunnels, which are basically 1 inch wide fold over elastics and 6 inches in length each, would be stitched on both sides of the wearer's headband for the purpose of holding the elastic cord as it circumvented the headband. One end of the elastic cord would securely tie to the base of a metal bobby pin, bent at a 45 degree angle, and then inserted through a small incision on the surface area of the ball. This makeshift anchor prevents the cord from popping out of the ball and in turn, provides a cleaner surface area upon impact which dramatically improves accuracy and precision as opposed to protruding anchors that corrupt the surface area of the ball. The other end of the elastic cord would enter the barrel cord lock which is held by the 3D printed top slide, and eventually circumvent the entire headpiece. The elastic cord would go through the first tunnel on either side, enter an additional bean cord lock in the back (which enables the wearer to hold back excess parts of the cord), go through the second tunnel on the other side of the wearer, and eventually come back out the barrel cord lock it first entered. The top slide would then “slide” into the 3D printed bottom holster and from there, the invention would be ready for use.

### APPENDIX

A hypothetical case study was conducted in two phases. Phase 1 lasted for a period of two weeks while Phase 2 was the immediate following day after the end of Phase 1. There were a total of three groups labeled A (Proto), B (No Proto), and C (Box) with ten members in each group. Group A was given prototypes of the utility patent to practice with every day for 15 minutes for the whole duration of Phase 1. Group B received no prototypes but regularly attended a gym daily to stay in shape and Group C consisted of a blend between amateur and professional athletes; specific to combat sports and trained on average 4-5 days a week, without the prototype. Nobody in either Group A or B held prior hand to hand combat experiences.

Phase 2 had every individual engage in three 1-minute rounds of reactionary light tests with a minute of rest in between rounds. This light test consisted of a large 5×5 panel with a total of 25 large buttons which would light up randomly. While standing, the individual would tap as many buttons that would light up and the average of all three rounds would conclude an individual's final count, which would in turn calculate into the group's average.

Upon the study's conclusion, the data reflected Group A's collective average to be significantly higher than those of Group B; while Group C retained the highest collective average. However, the max individual count within the sample of tested subjects originated from within 20% of Group A while the min originated from within Group B respectfully. Further tests and studies are to commence.

1. A headpiece apparatus comprising:
a headband member having a frontal holster;
a removable 3D printed component secured to said frontal holster of said headband;
an elastic cord with one end anchored within a ball and the other end entering through said 3D printed components, circumventing said headband before finally exiting out the said 3D printed component.

2. A headpiece apparatus as in claim 1, wherein said elastic cord is adjustable with respect to said headband member and one end of the elastic cord is fixed upon a metal bobby pin and inserted within said ball.

3. A headpiece apparatus as in claim 1, wherein said 3D printed component holds a barrel cord lock which enables said elastic cord's length to be adjusted, holstered and secured to said frontal portion of said headband member by a set of grosgrain ribbons.

4. A headpiece apparatus as in claim 3, wherein said headband member is made of Thermoplastic Elastomer allowing for a durable yet light and flexible option upon said headpiece.
